(19) United States
(12) Patent Application Publication
(10) Pub. No.: US 2008/0084831 A1
(43) Pub. Date: Apr. 10, 2008

(54) ACTIVE SOURCE IDENTIFICATION FOR CONFERENCE CALLS

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/535,677

(22) Filed: Sep. 27, 2006

(51) Int. Cl. H04L 12/16

(52) U.S. Cl. 370/260

(57) ABSTRACT

A conference bridge will receive incoming packet steams from multiple sources for a conference call. Packets within each of the incoming packet streams include audio signals from the corresponding source and source reference information, which uniquely identifies a source from which the packet was delivered. The conference bridge will identify one of the sources as an active source and deliver audio signals for the active source to the multiple sources in an outgoing packet stream. Packets in the outgoing packet stream will include active source reference information corresponding to the source reference information received for the active source. Based on the active source reference information, the sources may identify the source from which the audio signals in the outgoing packet stream correspond.

### FIELD OF THE INVENTION

The present invention relates to conference calls, and in particular to identifying an active source to other conference participants at any given time during a conference call.

### BACKGROUND OF THE INVENTION

Conference bridges are used to facilitate conference calls between two or more conference participants. In operation, multiple calls from multiple communication devices are terminated at a conference bridge. The audio levels for the audio signals from the different communication devices are monitored and used to identify a particular one of the audio signals to provide as an output to the communication devices. In general, the communication terminal providing the audio signal having the highest level at any given time is selected as the active communication terminal. The audio signals from the active communication terminal are provided to the communication devices in the conference. The audio signals from the unselected or inactive communication terminals are generally not provided to the communication devices. Only the audio signals provided by the selected communication terminal are presented to the other unselected communication terminals.

Conference participants at different locations often have difficulty identifying the conference participant who is currently talking. If the conference participants are relatively unfamiliar with each others' voices or certain conference participants sound alike, determining who is currently talking during a conference call is virtually impossible. However, knowing who is currently talking during a conference call is extremely helpful in deciphering the intent and content of the information provided by the conference participants.

In many instances, conference participants at different locations have difficulty determining who is participating in the conference call. If a conference participant remains quiet throughout the conference call, other conference participants at other locations may not be aware that the conference participant is engaged in the conference call.

As such, there is a need for an efficient and effective technique to identify the participant who is actively talking or her relative conference location during a conference call. There is a further need for conference participants be able to determine who is engaged in the conference call.

### SUMMARY OF THE INVENTION

A conference bridge is used to facilitate a conference call between multiple communication terminals. In operation, multiple calls from multiple communication terminals of the conference participants are terminated at the conference bridge. The audio signals from the different communication terminals are monitored by the conference bridge and used to identify an active communication terminal. The audio signals for the active communication terminal are provided to the communication terminals. Generally, the communication terminal providing the audio signals having the highest level at any given time is selected as the active communication terminal. The audio signals received from the active communication terminal are provided to all the communication terminals participating in the conference call except for the active communication terminal.

The audio signals received by the conference bridge and from the communication terminals are delivered in corresponding incoming packet streams. In addition to voice information representing the audio signals, packets within the incoming packet streams include unique source reference information that is associated with each of the communication terminals from which the packets are received. The audio signals received from the active communication terminal are provided by the conference bridge to the communication terminals in outgoing packet streams to the communication terminals. In addition to the voice information representing the audio signals, packets within the outgoing packet streams include active source reference information that is associated with the active communication terminal. The active source reference information is based on and may be or include in the source reference information for the packets received in the incoming packet stream for the active communication terminal. The packets in the outgoing stream may also include source reference information, which is associated with the conference bridge.

Separate from the outgoing packet streams, the conference bridge may deliver to the communication terminals conference information, including the source reference information for each of the communication terminals and participant information corresponding to the respective communication terminals. Based on the active source reference information in the packets of the outgoing packet stream, the communication terminals can determine the active source from which the audio signals in the outgoing packet steam are being received, and provide an appropriate alert to the corresponding conference participants using the participant information associated with the active source reference information to identify the active source. The alert may take many forms, such as providing text identifying the active source, providing a picture associated with the active source, or highlighting text, a picture, or other information associated with the active source.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is an illustration of a communication environment capable of supporting the present invention.

FIGS. 2A and 2B are a communication flow diagram illustrating the operation of the present invention according to one embodiment.

FIG. 3 illustrates an example of an active participant notification window according to one embodiment of the present invention.

FIG. 4 is an illustration of users in a virtual conference environment according to one embodiment of the present invention.

FIG. 5 is a flow diagram illustrating the operation of the present invention according to an alternative embodiment.

FIG. 6 is a block representation of a communication terminal according to one embodiment of the present invention.

FIG. 7 is a block representation of a conference bridge according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention allows communication terminals engaged in a conference call to identify the active conference participant or participants throughout a conference call. As different conference participants gain control of the conference, the respective communication terminals may alert the other conference participants of a change in the active participant, and identify the currently active participant. Prior to delving into the details of the present invention, an overview of a communication environment in which the present invention may be employed is described.

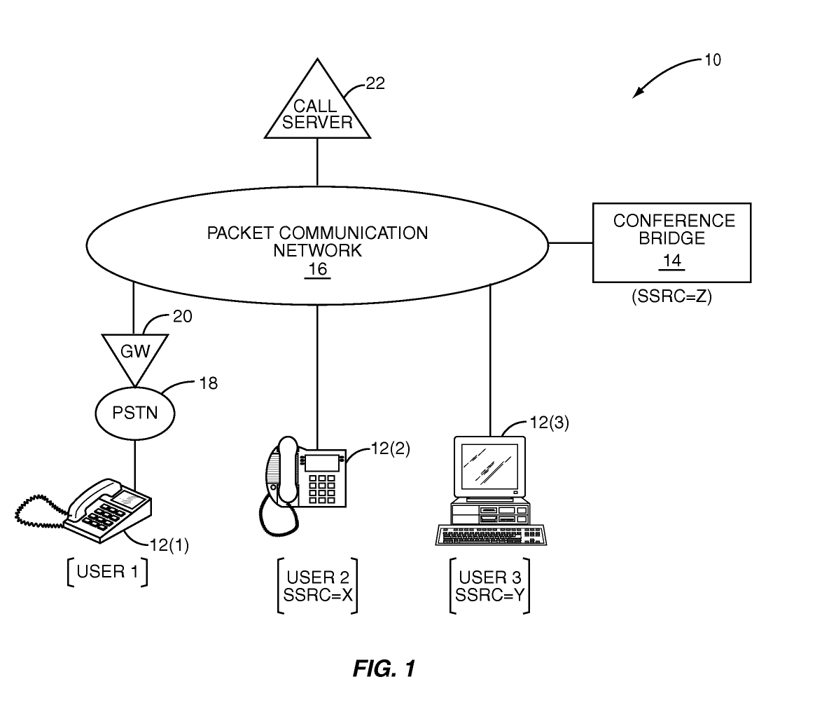

With reference to FIG. 1, a conference environment 10 is illustrated wherein various communication terminals 12(1-3) are able to establish a conference call with one another through a conference bridge 14 over a packet communication network 16. The communication terminals 12 may be directly connected to the packet communication network 16, as is the case for communication terminals 12(2-3), or indirectly via the Public Switched Telephone Network (PSTN) 18 via an appropriate gateway (GW) 20, as in the case of communication terminal 12(1). The communication terminals 12(2-3) and the gateway 20 may employ the services of a call server 22 to assist in facilitating calls with other communication terminals 12, as well as with the conference bridge 14. For illustration only, assume that user terminals 12(1-3) are associated with User 1, User 2, and User 3, respectively.

As noted, the conference bridge 14 is used to facilitate a conference call between multiple communication terminals 12. In operation, multiple calls from multiple communication terminals 12 of the conference participants (Users 1-3) are terminated at the conference bridge 14. The audio signals from the different communication terminals 12 are monitored by the conference bridge 14 and used to identify an active one of the communication terminals 12 that is referenced as active communication terminal 12′ in the text only for clarity. The audio signals for the active communication terminal 12′ are provided to the communication terminals 12. Generally, the communication terminal 12 providing the audio signals having the highest level at any given time is selected as the active communication terminal 12′. The audio signals received from the active communication terminal 12′ are provided to the communication terminals 12 participating in the conference call. The audio signals from the active communication terminals 12′ is not provided to the active communication terminal 12′.

The audio signals received by the conference bridge 14 from the communication terminals 12 are delivered in corresponding incoming packet streams over the packet communication network 16. In addition to voice information representing the audio signals, packets within the incoming packet streams include unique source reference information that is associated with each of the communication terminals 12 from which the packets are received. The audio signals received from the active communication terminal 12′ are provided by the conference bridge 14 to the communication terminals 12 in outgoing packet streams. In addition to the voice information representing the audio signals, packets within the outgoing packet streams include active source reference information that is associated with the active communication terminal 12′. The active source reference information is based on and may be or include the source reference information for the packets received in the incoming packet stream for the active communication terminal 12′. The packets in the outgoing stream may also include source reference information, which is associated with the conference bridge 14.

Separate from the outgoing packet streams, the conference bridge 14 may deliver to the communication terminals 12 conference information, including the source reference information for each of the communication terminals 12 and participant information corresponding to the respective communication terminals 12. Based on the active source reference information in the packets of the outgoing packet stream, the communication terminals 12 can determine the active source from which the audio signals in the outgoing packet steam are being received, and provide an appropriate alert to the corresponding conference participants using the participant information associated with the active source reference information to identify the active source. For example, the active source may be the active communication terminal 12′ or one or more conference participants associated with the active communication terminal 12′. As the active communication terminal 12′ changes, the active source reference information provided in the outgoing packet streams will change and the communication terminals 12 may provide corresponding alerts to the conference participants.

In one embodiment of the present invention, the Session Initiation Protocol (SIP) is used to establish the calls from the different communication terminals 12 to the conference bridge 14 for a conference call. The incoming and outgoing packet streams for these multiple calls may be controlled using the Real Time Protocol (RTP), and as such, the incoming and outgoing packet streams are RTP streams. Within RTP, the packet headers may include one or more source reference code fields in which a synchronization source reference code (SSRC) and a contributing source reference code (CSRC) may be provided. In one embodiment, the present invention uses an SSRC to provide the source reference information, and the CSRC to provide the active source reference information. With reference to FIG. 1, assume communication terminal 12(2) is associated with an SSRC of X; communication terminal 12(3) is associated with an SSRC of Y; and the conference bridge is associated with an SSRC of Z. Further assume that only communication terminals 12(2-3), which are associated with Users 2 and 3, are participating in the conference call.

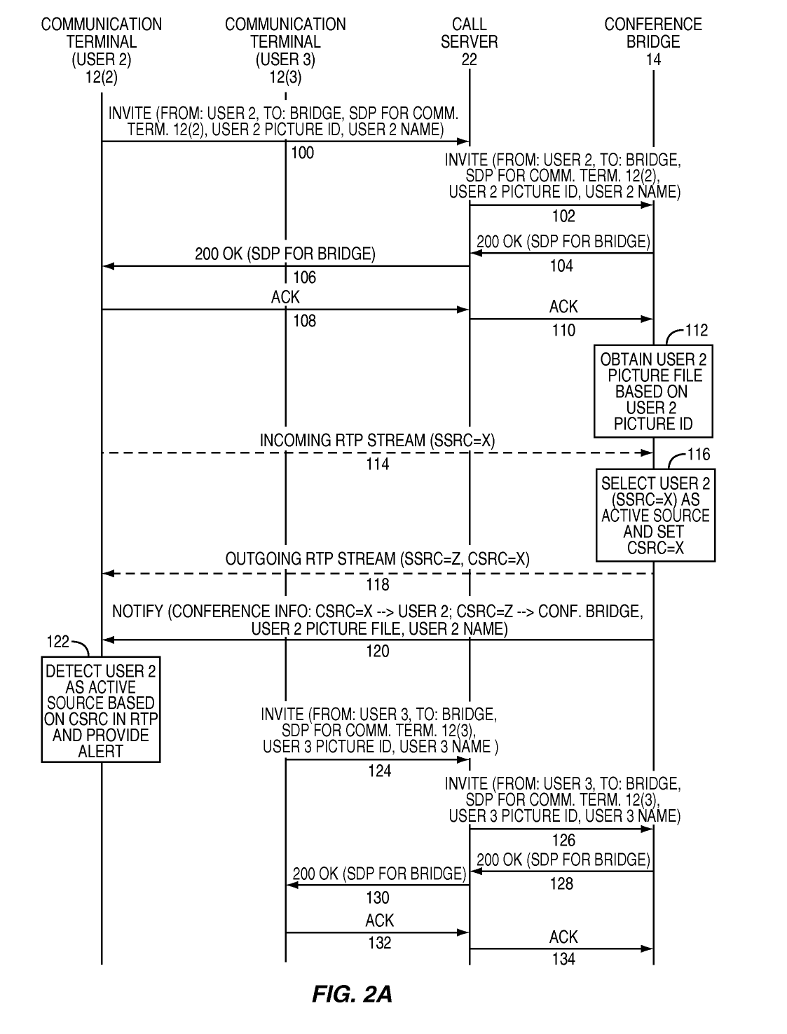

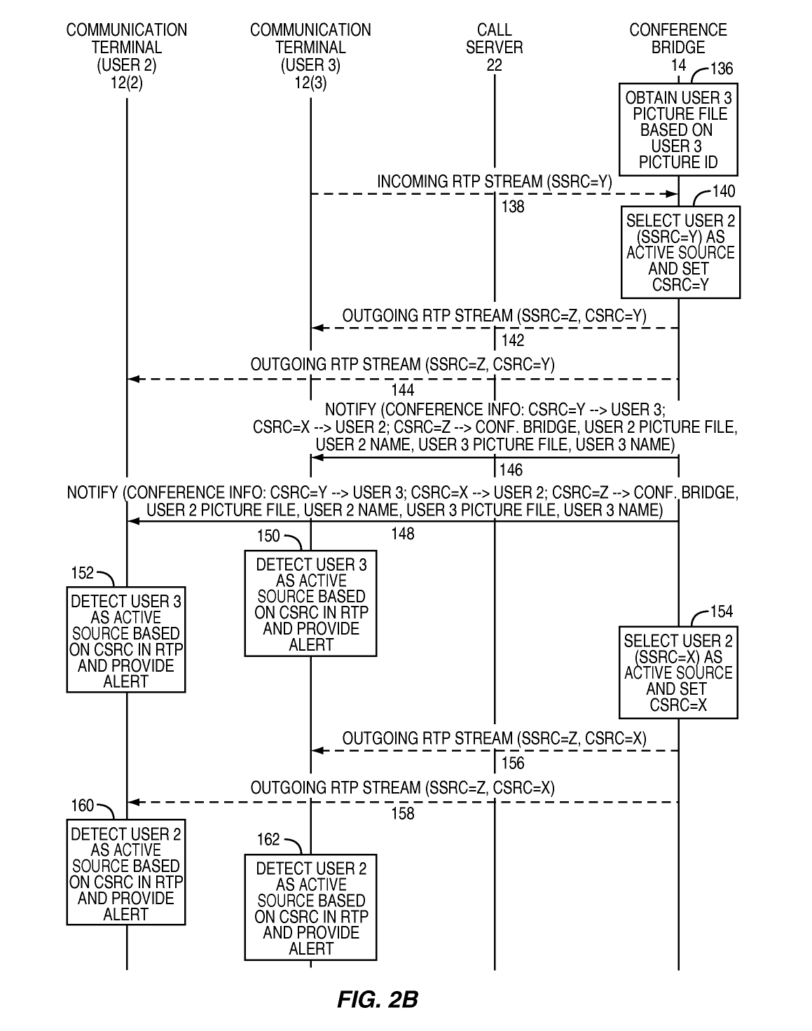

With reference to FIGS. 2A and 2B, a communication flow is provided to illustrate establishment of a conference call and allowing the communication terminals 12(2-3) to provide an alert to Users 2 and 3 to identify the active participant. Although the interaction between the conference bridge 14, call server 22, and communication terminals 12(2-3) are illustrated, those skilled in the art will recognize that the conference bridge 14 may be supporting any number of other conference participants, and that the communication flow may be extended in a similar fashion for those conference participants.

Initially, assume that User 2 initiates a call into the conference bridge 14, wherein the communication terminal 12(2) will send an Invite message to the call server 22 (step 100). The Invite message will indicate that the call is from User 2 and is intended for the conference bridge 14. The Invite message may also identify the Session Data Protocol (SDP) for the communication terminal 12(2), along with participant information associated with User 2 or the communication terminal 12(2). The participant information in this example is User 2's name as well as an identifier for a picture file associated with User 2. The call server 22 will forward the Invite message to the conference bridge 14 (step 102), which will respond by sending a 200 OK message, including the SDP for the conference bridge 14, to the call server 22 (step 104). The call server 22 will forward the 200 OK message to the communication terminal 12(2) (step 106), which will respond with an Acknowledgement message (ACK), which is forwarded to the conference bridge 14 through the call server 22 (steps 108 and 110). Meanwhile, the conference bridge 14 may obtain the picture file associated with User 2 based on the picture ID provided in the Invite message, which was originated from communication terminal 12(2) (step 112).

Once the communication terminal 12(2) has the SDP information for the conference bridge 14, an incoming RTP stream of packets may be delivered to the conference bridge 14 (step 114). Notably, the communication terminal 12(2) will include the SSRC (X) for the communication terminal 12(2) in the RTP headers of the packets in the incoming RTP stream. The conference bridge 14 will receive the incoming RTP stream, and may select User 2 as the active source, as well as set the CSRC to identify User 2 as the active source (step 116). Since User 2 is the active source, the audio signals from communication terminal 12(2) are sent to the communication terminals 12 that are currently engaged in the conference call. At this point, only communication terminal 12(2) is engaged in the conference call, and as such, an outgoing RTP stream is only sent to the communication terminal 12(2) (step 118). Notably, the conference bridge 14 will include the CSRC (X) for User 2, who is the active source, in the packet header of the packets in the outgoing RTP stream. The SSRC in the outgoing RTP stream may identify the conference bridge 14 (SSRC=Z). The audio content in the RTP stream sent to the active communication terminal 12(2) is actually muted to eliminate the unnecessary audio feedback to User 2. This audio handling may be performed for any communication terminal 12 when it becomes the active communication terminal.

Outside of the outgoing RTP streams, the conference bridge 14 will provide conference information to the communication terminals 12. As illustrated, the conference bridge 14 will generate conference information identifying the CSRC values for the currently active participants, as well as for the conference bridge 14. In this instance, the CSRC (X) for User 2 is provided, along with participant information associated with User 2. The participant information may include the name for User 2, as well as the picture file for User 2, which was obtained earlier using the picture ID for User 2. The conference information may be provided to the communication terminal 12(2) in a Notify message (step 120). Upon receipt of the conference information, the communication terminal 12(2) may detect that User 2 is the active source based on the CSRC provided in the outgoing RTP stream, and provide an appropriate alert to the conference participant or participants associated with communication terminal 12(2) (step 122).

Next, assume that User 3 initiates a call into the conference bridge 14, wherein the communication terminal 12(3) will send an Invite message to the call server 22 (step 124). The Invite message will indicate that the call is from User 3 and is intended for the conference bridge 14. The Invite message may also identify the SDP for the communication terminal 12(3), along with participant information associated with User 3 or the communication terminal 12(3). The participant information in this example is User 3's name as well as an identifier for a picture file associated with User 3. The call server 22 will forward the Invite message to the conference bridge 14 (step 126), which will respond by sending a 200 OK message, including the SDP for the conference bridge 14, to the call server 22 (step 128). The call server 22 will forward the 200 OK message to the communication terminal 12(3) (step 130), which will respond with an Acknowledgement message (ACK), which is forwarded to the conference bridge 14 through the call server 22 (steps 132 and 134). Meanwhile, the conference bridge 14 may obtain the picture file associated with User 3 based on the picture ID provided in the Invite message, which was originated from communication terminal 12(3) (step 136).

Once the communication terminal 12(3) has the SDP information for the conference bridge 14, an incoming RTP stream of packets may be delivered to the conference bridge 14 (step 138). At this point, Users 2 and 3 are participating in the conference call. When the conference bridge 14 selects User 3 as the active source, the CSRC is changed from X to Y (step 140), and the outgoing RTP streams to communication terminals 12(2-3) will deliver the audio signals received from communication terminal 12(3). The RTP packet headers of the packets in the outgoing RTP streams will include a CSRC of Y to indicate that User 3 is the active source. The SSRC continues to be set at Z, since the conference bridge 14 is continuing to provide the outgoing RTP streams (steps 142 and 144).

Based on the new active source, the conference bridge 14 will provide updated conference information to the communication terminal 12(3) and the communication terminal 12(2) in the form of SIP Notify messages (steps 146 and 148). The conference information will identify the possible CSRC values that may be provided in the outgoing RTP streams. In this example, the CSRC values may be set to X when User 2 is the active source, Y when User 3 is the active source, and Z when the conference bridge 14 is the active source. The conference information may also include the participant information for both User 2 and User 3. Upon receipt of the Notify messages, communication terminal 12(2) and communication terminal 12(3) may then infer that User 3 is the active source based on the CSRC in the outgoing RTP stream and provide appropriate alerts to the corresponding conference participants (steps 150 and 152).

During the conference call, when User 3 stops talking and User 2 begins talking, the conference bridge 14 will detect that the audio signals coming from communication terminal 12(2) are dominant, and will select User 2 as the active source and set the CSRC in the outgoing RTP stream to X (steps 154, 156, and 158). Both communication terminal 12(2) and communication terminal 12(3) will detect that User 2 is the active source based on the CSRC in the outgoing RTP stream, and will provide appropriate alerts to the corresponding conference participants (steps 160 and 162). This process will continue throughout the conference call, such that the various conference participants may be alerted to the currently active source in a dynamic fashion.

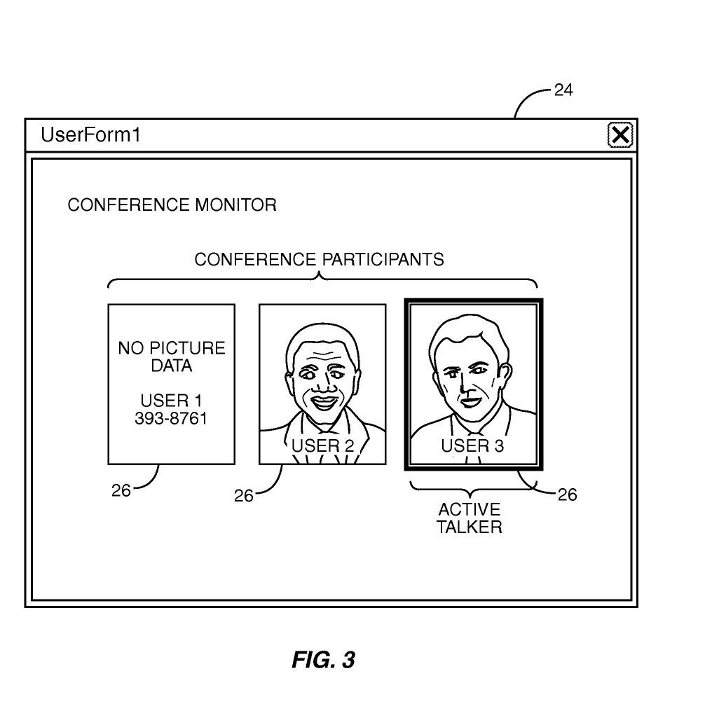

FIG. 3 illustrates an exemplary alert that may be provided to a conference participant. In general, a window 24 provided on the communication terminal 12(2) or 12(3) may provide the picture files 26 for User 2 and User 3 to identify conference participants. In FIG. 3, User 1 is also a conference participant, yet there is no picture data; therefore, the directory number associated with communication terminal 12(1) is provided to assist in identifying User 1. In addition to the pictures of User 2 and User 3, the names of the respective conference participants may be provided. In this example, the active talker is highlighted by placing a frame around the picture 26 with the participant information. In this example, User 3 is the active talker.

Although the prior illustrations only identified two conference participants, any number of conference participants may be supported by the conference bridge 14. Further, if the conference bridge 14 is configured to select multiple audio signals from different sources to provide in the outgoing audio streams to the various communication terminals 12, the active source reference information may include CSRCs for the multiple sources. Although the SSRCs and CSRCs are used for illustration, those skilled in the art will recognize that virtually any type of information may be used to provide the source reference information and the active source reference information according to the concepts of the present invention.

In another embodiment of the present invention, the active source reference information is employed along with virtual conference information to assist in processing audio signals from the outgoing audio streams to inject virtual location information. In other words, the local conference participant will hear audio signals for the remote conference participants relative to their virtual locations, which may include position and orientation components.

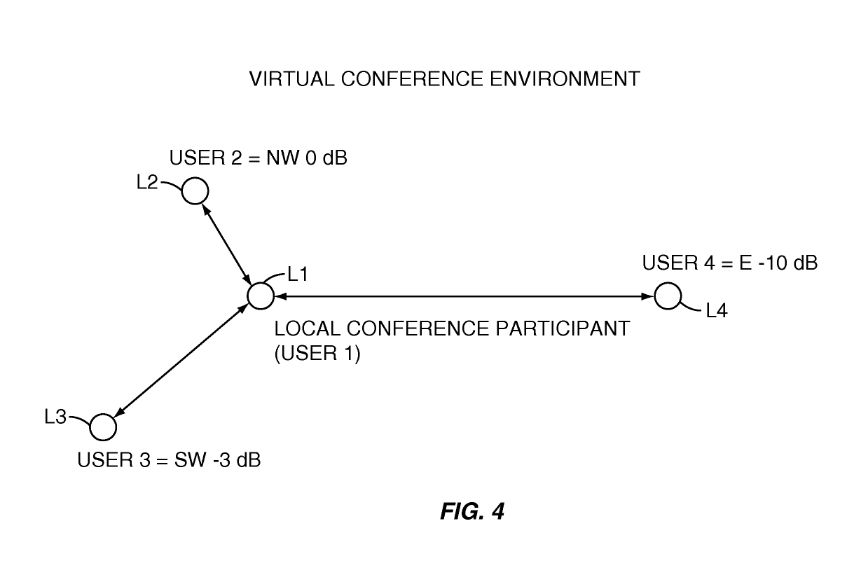

Turning now to FIG. 4, an example virtual conference environment is illustrated where a local conference participant, User 1, has a virtual location L1 and the other remote conference participants, Users 2-4, have virtual locations L2, L3, and L4, respectively. In essence, User 2 is located northwest (NW) of User 1 and User 2's audio signals are not attenuated (0 dB). User 3 is southwest (SW) of User 1 and is farther away from User 1 relative to User 2. As such, the audio signals from User 3 are attenuated by −3 dB to represent the attenuation in the audio signals that would occur due to User 3 being farther away from User 1. Similarly, User 4 is located east (E) of User 1 at location L4. Location L4 is farther away from location L1 than either of locations L2 or L3. As such, the audio signals from User 4 will be attenuated more than the audio signals from User 3. In this example, the audio signals from User 4 are attenuated by −10 dB. From the virtual conference environment, various audio parameters may be derived to represent the relative locations and positions of the remote conference participants to the local conference participant. These parameters, directly or indirectly, generally represent direction and distance information. Such information is generally referred to as “audio position information,” which may be used by the communication terminal 12 or associated audio system to process the various audio signals from Users 2-4 such that the audio signals sound as if they are coming from the relative positions of Users 2-4 with respect to User 1 in the virtual conference environment.

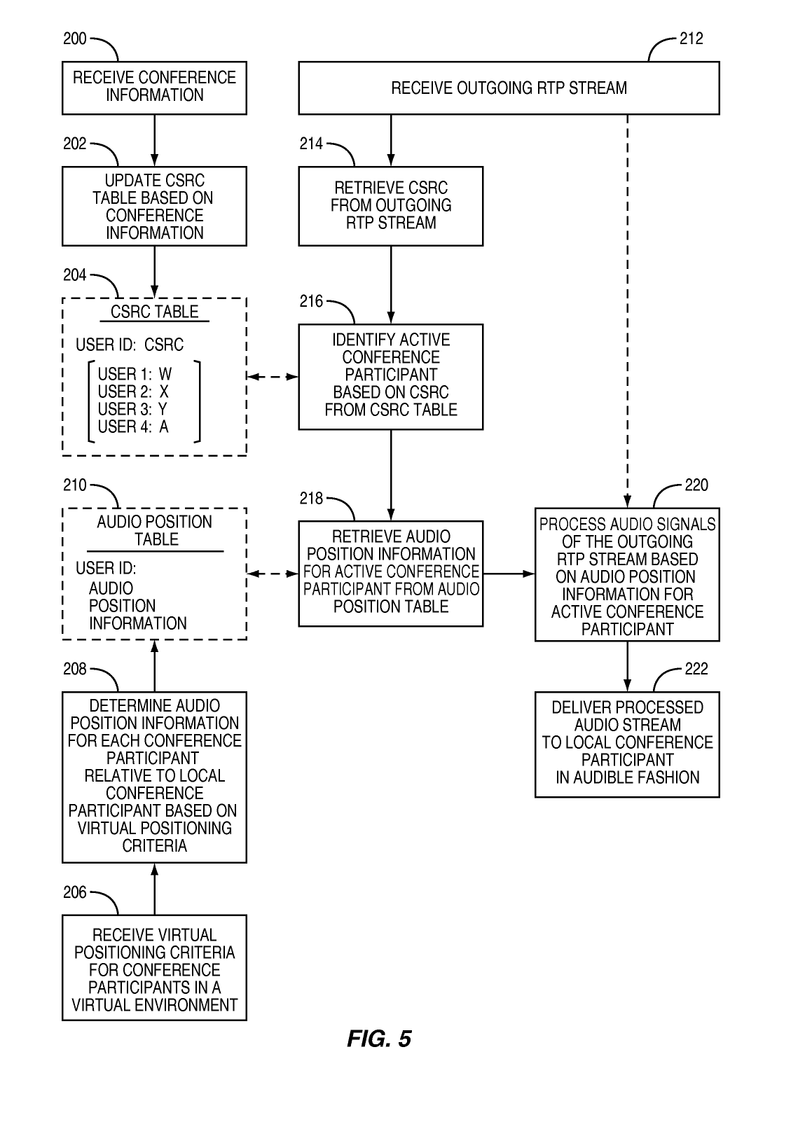

With reference to FIG. 5, a communication flow is provided to illustrate the operation of a virtual conference environment according to the current embodiment of the present invention. Initially, the communication terminal 12 may receive conference information from the conference bridge 14 (step 200), and update a CSRC table based on the conference information (step 202). In this example, the CSRC table identifies each of the users in the virtual conference environment of FIG. 4. User 1 is the local conference participant and has a CSRC equal to W, while the remote conference participants are Users 2-4, which have CSRCs of X, Y, and A, respectively (step 204). Although the CSRC is used in this example, any type of source reference information or active source reference information may be used to construct an appropriate table. The CSRC table is merely used to be consistent with the prior embodiments. The CSRC table is updated as conference participants change. Further, the CSRC table may include audio position information as described above.

Meanwhile, the system keeping track of the virtual communication environment, which may be the communication terminal 12 or an associated controller, such as a game controller or personal computer, will obtain or receive virtual positioning criteria for conference participants in a virtual environment (step 206). The virtual positioning criteria may be generated by the controller or may be received over a communication network, such as the Internet. Based on the virtual positioning information for the conference participants, audio position information is determined for each conference participant relative to the local conference participant (step 208). The audio position information for the local conference participant is stored in an audio position table (step 210). As such, the audio position table for a local conference participant will include audio information for each of the remote conference participants engaged in the conference call for the virtual conference environment. As the conference participants move with respect to one another throughout the virtual conference environment, the audio position information is updated in the audio position table.

As the conference call proceeds, the communication terminal 12 will receive the outgoing RTP stream from the conference bridge 14 (step 212) and retrieve the CSRC from the outgoing RTP stream (step 214). The communication terminal 12 will then identify the active participant (or source) based on the CSRC recovered from the outgoing RTP stream and the CSRC table (step 216), as the CSRC table will associate the given CSRC provided in the outgoing RTP stream with a particular user ID or like source identifier. Next, the audio position information for the active conference participant is retrieved from the audio position table (step 218). In particular, the audio position table will include audio position information for each of the remote conference participants. In this step, the audio position information for the active one of the remote conference participants or for the local participant, as the case may be, is retrieved. The communication terminal 12 will then use the audio position information to process the audio signals of the outgoing RTP stream based on the audio position information for the active participant (step 220) and deliver the processed audio stream to the local participant in an audible fashion (step 222).

The audible signals provided to the local conference participant will sound as if they are coming from the active conference participant from a relative location corresponding to the relative location between the local conference participant and the active conference participant in the virtual conference environment. Such functionality may be provided by the conference bridge 14, wherein different outgoing RTP streams would be provided to the respective communication terminals 12. The audio signals in each of the outgoing RTP streams would be processed in light of the audio position information in light of the local conference participant for each communication terminal 12 and the active conference participant.

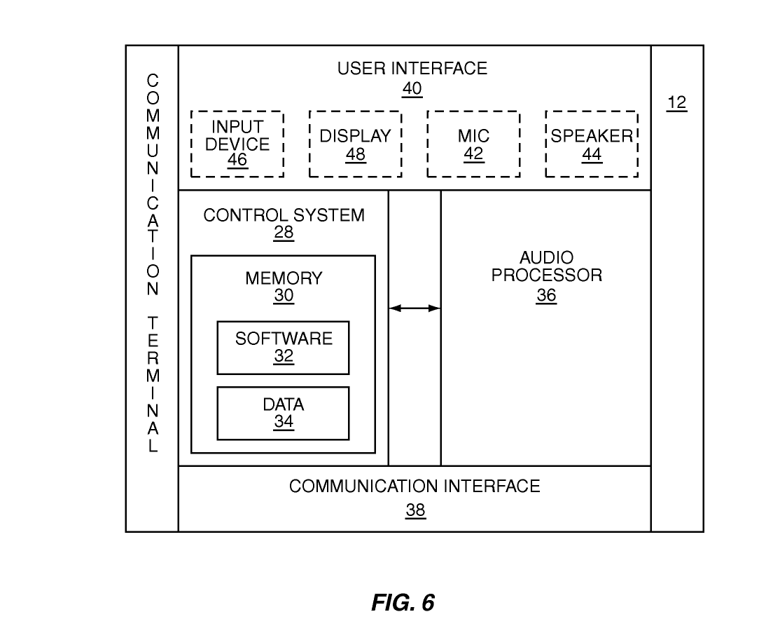

With reference to FIG. 6, a block representation of a communication terminal 12 is illustrated according to one embodiment of the present invention. The communication terminal 12 may include a control system 28 having sufficient memory 30 for the requisite software 32 and data 34 to operate as described above. The control system 28 may include or be associated with an audio processor 36 to facilitate processing of audio signals carried in the outgoing RTP streams or other packet streams in light of audio position information for the active participant. The control system 28 and the audio processor 36 may be associated with a communication interface 38 to facilitate communications directly or indirectly with the conference bridge 14 or other communication nodes, as well as a user interface 40 to facilitate interaction with one or more users associated with the communication terminal 12. The user interface 40 may include a microphone (MIC) 42, speaker 44, input device 46, and display 48 to facilitate bidirectional audio communications, including voice, as well as provide information to the user and receive information from the user.

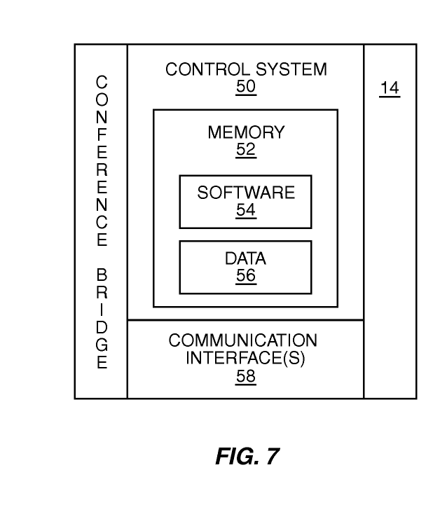

With reference to FIG. 7, a block representation of a conference bridge 14 is illustrated according to one embodiment of the present invention. The conference bridge 14 includes a control system 50 having sufficient memory 52 for the requisite software 54 and data 56 to operate as described above. The control system 50 is also associated with one or more communication interfaces 58 to facilitate communications with the various communication terminals 12 as well as with other communication nodes directly or indirectly associated with the packet communication network 16.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving incoming packet streams from a plurality of sources for a conference call, packets within each of the incoming packet streams comprising audio signals from one of the plurality of sources and source reference information, which uniquely identifies the one of the plurality of sources from which the packets are delivered;
identifying an active source from the plurality of sources; and
delivering the audio signals for the active source to at least one of the plurality of sources in an outgoing packet stream, packets in the outgoing packet stream comprising active source reference information corresponding to the source reference information received for the active source.

2. The method of claim 1 further comprising providing to the plurality of sources conference information comprising the source reference information for the plurality of sources and participant information associated with each of the plurality of sources.

3. The method of claim 2 wherein the conference information is provided to the plurality of sources outside of the outgoing packet streams.

4. The method of claim 2 wherein each of the plurality of sources are configured to retrieve the active source reference information from the outgoing packet streams and identify the active one of the plurality of sources based on the conference information and the active source reference information.

5. The method of claim 2 further comprising providing to the plurality of sources participant information associated with each of the plurality of sources.

6. The method of claim 5 further comprising receiving at least a portion of the participant information associated with each of the plurality of sources from the incoming packet streams.

7. The method of claim 5 further comprising obtaining at least a portion of the participant information from an entity other than the plurality of sources.

8. The method of claim 5 wherein the participant information identifies conference participants associated with the plurality of sources.

9. The method of claim 5 wherein the participant information is at least one of a group consisting of picture files and picture file identifiers associated with the plurality of sources.

10. The method of claim 2 wherein when the plurality of sources participating in the conference call change, updated conference information reflecting the changes is provided to the plurality of sources.

11. The method of claim 1 wherein the incoming packet streams and the outgoing packet streams are real time packet streams; the source reference information is source reference codes provided in a source reference field in a header of the packets in the incoming packet streams; and the active source reference information is one of the source reference codes, which is associated with the active source and provided in a source reference field of in a header of the packets in the outgoing packet streams.

12. The method of claim 1 wherein the active source reference information provided in the outgoing packet streams changes as different ones of the plurality of sources are selected as the active source.

13. The method of claim 1 wherein packets in the outgoing packet streams further comprise source reference information associated with a conference bridge.

14. A conference bridge comprising:
at least one communication interface; and
a control system associated with the at least one communication interface and adapted to:
receive incoming packet streams from a plurality of sources for a conference call, packets within each of the incoming packet streams comprising audio signals from one of the plurality of sources and source reference information, which uniquely identifies the one of the plurality of sources from which the packets are delivered;
identify an active source from the plurality of sources; and
deliver the audio signals for the active source to at least one of the plurality of sources in an outgoing packet stream, packets in the outgoing packet stream comprising active source reference information corresponding to the source reference information received for the active source.

15. The conference bridge of claim 14 wherein the control system is further adapted to provide to the plurality of sources conference information comprising the source reference information for the plurality of sources and participant information associated with each of the plurality of sources.

16. The conference bridge of claim 15 wherein the conference information is provided to the plurality of sources outside of the outgoing packet streams.

17. The conference bridge of claim 15 wherein each of the plurality of sources are configured to retrieve the active source reference information from the outgoing packet streams and identify the active one of the plurality of sources based on the conference information and the active source reference information.

18. The conference bridge of claim 15 wherein the control system is further adapted to provide to the plurality of sources participant information associated with each of the plurality of sources.

19. The conference bridge of claim 18 wherein the control system is further adapted to receive at least a portion of the participant information associated with each of the plurality of sources from the incoming packet streams.

20. The conference bridge of claim 18 wherein the control system is further adapted to obtain at least a portion of the participant information from an entity other than the plurality of sources.

21. The conference bridge of claim 18 wherein the participant information identifies conference participants associated with the plurality of sources.

22. The conference bridge of claim 18 wherein the participant information is at least one of a group consisting of picture files and picture file identifiers associated with the plurality of sources.

23. The conference bridge of claim 15 wherein when the plurality of sources participating in the conference call changes, updated the conference information reflecting the changes is provided to the plurality of sources.

24. The conference bridge of claim 14 wherein the incoming packet streams and the outgoing packet streams are real time packet streams; the source reference information is source reference codes provided in a source reference field in a header of the packets in the incoming packet streams; and the active source reference information is one of the source reference codes, which is associated with the active source and provided in a source reference field of in a header of the packets in the outgoing packet streams.

25. The conference bridge of claim 14 wherein the active source reference information provided in the outgoing packet streams changes as different ones of the plurality of sources are selected as the active source.

26. The conference bridge of claim 14 wherein packets in the outgoing packet streams further comprise source reference information associated with the conference bridge.
